(19) United States
(12) Patent Application Publication
(10) Pub. No.: US 2009/0264277 A1
(43) Pub. Date: Oct. 22, 2009

(54) Picoscale catalysts for hydrogen catalysis

(75) Inventors: RISHI RAJ, Boulder, CO (US); GIOVANNI CARTURAN, Padova (IT); RAQUEL de la PENA-ALONSO, Fresnedillas de la Oliva (ES)

Correspondence Address: Rishi Raj, 863 14th Street, Boulder, CO, 80302, US

(73) Assignee: Dr. Rishi Raj, Boulder, CO (US)

(21) Appl. No.: 12/148,185

(22) Filed: Apr. 17, 2008

Related U.S. Application Data
(60) Provisional application No. 60/912,208, filed on Apr. 17, 2007.

(51) Int. Cl. B01J 27/02; B01J 21/06; B01J 27/06; B01J 21/18; B01J 27/24; B01J 27/182; B01J 35/00

(52) U.S. Cl. 502/4; 502/240; 502/258; 502/261; 502/260; 502/262; 502/216; 502/224; 502/182; 502/200; 502/214; 977/701; 977/902

(57) ABSTRACT

A catalyst for hydrogen generation from an alkaline aqueous solution of hydrogen containing salts comprising a silicon-based ceramic surface covered with a mixture of metals known as transition metals and noble metals. The silicon-based ceramic surface may be self-supporting or may be deposited as a thin film on a carbonaceous substrate. The carbonaceous surface may be self-supporting or be in the form of a film that is supported on a substrate of a fourth material, where the fourth material has the function of providing physical support to the substrate. The said carbonaceous substrate can be made from a solid material or from a porous structure, of which carbon nanotube paper, also known as Bucky paper, is one example.

### CROSS-REFERENCE TO RELATED APPLICATIONS

This application claims the benefit of U.S. Provisional Patent Application No. 60/912,208, filed on Apr. 17, 2007, incorporated by reference herein.

### STATEMENT REGARDING FEDERALLY SPONSORED RESEARCH OR DEVELOPMENT

This invention was made with government support under Grant No. DE-FC26-03NT41967 awarded by the National Energy Technology Laboratory-Department of Energy. The government has certain rights in the invention.

### BACKGROUND OF THE INVENTION

1. Field of Invention

This invention relates to catalysts for the purpose of releasing hydrogen from aqueous solutions of hydride salts at a controlled rate.

2. Discussion of Prior Art

Hydride salts such as NaBH₄ or LiBH₄ constitute safe and practical hydrogen reservoirs for PEM (polymer-electrolyte membrane) fuel cells. The hydrides are non-toxic, non-inflammable, produce pure hydrogen, and carry a superior weight and volumetric capacity for hydrogen delivery (Schlapbach, 2001). For these reasons, these hydrides are likely to be the prime candidates as the fuel for cells (Amendola 2001; Cowey 2004) designed for a few watts of electrochemically derived power. However, much larger systems, delivering several kW, are considered feasible with the assumption that the cost of production of NaBH₄ will fall with increasing demand (Kojima 2004; Tsuchiya 2004). While direct-borohydride fuel cells, where the hydride is used directly as the anodic fuel are being developed, the two step, serial configuration where the hydrogen production and its conversion to electric power occurs sequentially appears more feasible for commercial use at the present time (Wee, 2006). The figure of merit (FOM) for such a system is the rate of hydrogen production per gram of the metal catalyst, per molar concentration of NaBH₄ (L min⁻¹ gₘₑₜ⁻¹ [NaBH₄]-1). The rate of hydrogen generation is directly linked to the power delivery capacity; for example a rate of 1 L min⁻¹ at 0.7 V is equivalent to 0.1 kW. Control implies being able to predict the conversion rate from system parameters such as feed rate, power load and temperature. Reliability refers to long-term performance of the catalyst without degradation.

A successful catalyst must not only be able to deliver a high production rate of hydrogen (liters of hydrogen generated per minute, per gram of the catalyst), but the rate of hydrogen production rate must be predictable and controllable (like the gas pedal in a gasoline powered car). Catalysts are necessary for controlled rate of hydrogen production from hydride salts. For example, on its own sodium borohydride, at first reacts virulently with water (Schlesinger 1953; James 1970) but the reaction rate diminishes with time as the production of sodium borate makes the solution alkaline. Controlled production of hydrogen is obtained by buffering the solution at a high pH and then using a catalyst. Studies that can predict the production rate of hydrogen, in the presence of a catalyst, are limited (Kojima 2006; Krishnan 2005). One study considers Pt nanoclusters dispersed on LiCoO₂ substrate (Kojima 2006) the other a suspension of Ru nanoclusters (Krishnan 2005). Both report the rate of hydrogen production is independent of the molar concentration of sodium borohydride; however, these reactions were not studied over a wide range of hydride salt concentrations. Therefore, the study of the activity of various catalysts remains somewhat disconnected, making it difficult to draw clear conclusions about the choice of the best catalyst for predictable and reliable service in a fuel cell. At the present time the key observations are: the production rate of hydrogen ranges from 0.2 to 2.8 L min⁻¹ gₘₑₜ⁻¹ (Wee 2006), the rate of hydrogen production is not reliable, and that the chemistry of the catalyst, and its support, influence its performance.

The cost of the catalyst is predominantly determined by the amount of metal needed to generate hydrogen at a certain rate. Therefore, the said FOM is defined as the rate of hydrogen production per gram of the metal. The metal is usually deposited on a substrate, which serves as the physical embodiment of the catalyst. The metal atoms are expected to reside in the form of clusters on the substrate. The “geometric catalytic efficiency” of the metal cluster depends on the number of atoms residing on its surface, while the weight of the cluster depends on the volume of the cluster, that is, on the total number of atoms in the cluster. Only the atoms residing on the surface of the clusters participates in catalysis (Boudard 1969). Smaller clusters have a larger fraction of their atoms placed on the surface. Therefore, smaller clusters have a greater “geometric catalytic efficiency”, since less weight of the metal is required to produce the same rate of hydrogen generation. However, another property can influence the “geometric catalytic efficiency”: this is known as the contact angle that the metal cluster forms with the substrate. This contact angle is denoted as e in FIG. 1. In the limiting case θ→b 0 [symbol] ; in this case the metal atoms become dispersed individually on the substrate, which leads to the highest possible “geometric catalytic efficiency”. In the configuration θ→0 [symbol] in FIG. 1 the metal atoms are distributed in the picoscale.

A comprehensive review of the literature leads to the plot shown in FIG. 2, which gives the hydrogen generation rate from sodium borohydride as a function of cluster size. The scatter in the data is significant (James 1970; Brown 1962; Amendola 2002; Amendola 2000; Suda 2001; Wu 2004), but a definite trend towards a higher figure of merit (expressed as L min⁻¹ gₘₑₜ⁻¹ [NaBH₄]⁻¹) with the decrease of the cluster size is evident.

The physical architecture of the catalyst has a bearing on the design of the system that delivers hydrogen at a high and a predicable rate at the lowest possible cost. Two possible designs are (a) where the catalyst is in the form of a powder of small particles, and (b) where the active catalyst is deposited on a continuous substrate that can be handled like a cloth, or a paper. The type (a) catalysts have been most extensively studied; as for example nanocrystalline Pt and Ru, supported on various oxide substrates (Kojima 2002; Kojima 2006; Krishnan 2005). Occasionally free floating clusters of the catalysts, such as Ru (Ozkar 2005) and cobalt-boride (Wu 2005) have also been reported but unsupported catalysts are unlikely to be practical.

It is noted that precious metals such as platinum are known to catalyze a number of other chemical reactions. Several scientific papers report preparation of platinum deposited on single or multi-wall carbon nanotubes. Chemical deposition of platinum on activated (oxidized) nanotubes has been reported by Lordi 2001, Li 2002, and Liu 2002. Electrodeposition of platinum onto arrays of carbon nanotubes has been reported by Tang 2004. Use of carbon nanotubes as catalyst supports has also been mentioned in the patent literature (U.S. Pat. No. 6,680,279 to Cai et al “Nanostructural Catalyst Particle/Catalyst Carrier Particle System”; U.S. Pat. No. 7,132,385 to Pak et al “High Loading Supported Carbon Catalyst, Method of Preparing the Same, Catalyst Electrode Including the Same, and Fuel Cell Including the Catalyst Electrode”; U.S. Patent Publication US2005/0085379 to Ishihara et al “Electrode Catalyst Fine Particles Dispersion of the Same and Process for Producing the Dispersion”).

It is noted that coverage of single wall carbon nanotubes with organic molecules has been reported in U.S. Pat. No. 6,841,139 to Margrave et al. The '139 patent, however, excludes the attachment of silicon-containing molecules to the carbon nanotube surfaces, and especially of ceramic molecules to carbon nanotube surfaces that are constituted from silicon, as described in Shah and Raj 2005.

### BRIEF SUMMARY OF THE INVENTION

The invention is a catalyst-system for the hydrogen catalysis that comprises a combination of at least two layers consisting of a metal-layer, and a silicon-based layer. The silicon-based layer may be supported on a porous layer, and the porous-layer may be further supported on a substrate. The shape of the catalyst-system has a shape selected from the group consisting of a sheet, a fiber, individual particles, and combinations thereof.

The metal-layer comprises a metal selected from the group consisting of transition metals, noble metals, and oxides, sulphides, halides, carbides, nitrides, phosphides and silicides of such metals. The metal-layer is disposed adjacent the silicon-based layer. The silicon-based layer further includes one or more elements selected from the group consisting of carbon, nitrogen, oxygen, boron, phosphorus, aluminum, and combinations thereof.

Without wishing to be bound by any particular theory, said silicon-based layer is believed to assist in dispersion of the metals into a monolayer or a submonolayer, thus creating a picoscale catalyst, which is expected to have the highest possible catalytic efficiency arising from said metals. When the silicon-based layer is deposited on the porous layer then the active surface area of the catalyst is extended, provided that the porous layer is made from a conducting material.

### BRIEF DESCRIPTION OF THE DRAWINGS

FIG. 1: The influence of contact angle on the surface to volume ratio of the cluster. Elemental, or picoscale dispersion of the metal atoms can be obtained if the contact angle, 0, approaches zero.

FIG. 2: A plot of the figure of merit (FOM) for the catalyst as a function of the cluster size of the metal atoms. The present work yields a FOM that is 100% to 1000% greater than reported in the literature.

FIG. 3: The architecture of an exemplary catalyst comprising a picoscale metal layer, which is adjacent to a silicon-based ceramic interlayer, which, in turn, is deposited on a porous carbonaceous substrate.

FIG. 4: The architecture of an embodiment of the catalyst comprising a picoscale metal layer deposited on a silicon-based ceramic.

FIG. 5: The architecture of an embodiment of the catalyst comprising a picoscale metal layer deposited on a silicon-based ceramic interlayer, deposited on thin porous carbonaceous interlayer deposited on a substrate to facilitate physical handling.

FIG. 6: An embodiment of the architecture described in FIG. 3 where the porous substrate is made from carbon-nanotube paper.

FIG. 7: Hydrogen production as a function of time for four molar concentrations of NaBH₄ at 29° C. and pH 13.

FIG. 8: Hydrogen production at four different temperatures with a 0.03M NaBH₄ solution.

FIG. 9: The FOM increasing with decreasing thickness of the carbon-nanotube paper as in FIG. 6.

FIG. 10: The proposed mechanism for the catalytic production of H₂ from an aqueous solution of NaBH₄.

FIG. 11: Theoretical analysis of the H₂ release data in terms of zero order and first order kinetics.

FIG. 12: Temperature dependence of the hydrogen generation rate.

### DESCRIPTION OF THE NUMERICAL POINTERS IN THE FIGURES

1. The contact angle, or the wetting angle, formed by the metal cluster on the surface of the catalyst.
2. The atoms of the metal(s) dispersed in a sub-monolayer on the substrate.
3. The metal cluster with an contact angle greater than zero is not as efficient as the picoscale dispersion since only the atoms on the surface of the metal cluster are active in catalysis.
4. The figure-of-merit achieved in an embodiment where the carbon-nanotube paper is approximately 150 micrometers thick, serving the functions of a porous-layer and the substrate.
5. The figure-of-merit achieved in an embodiment with carbon-nanotube paper having a thickness in the range 20-75 micrometers.
6. The picoscale metal overlayer of the catalyst deposited on 7.
7. The silicon-based ceramic interlayer of the catalyst.
8. The porous carbonaceous substrate supporting 7.
9. The picoscale metal overlayer deposited on a silicon-based ceramic substrate.
10. The silicon-based ceramic substrate supporting the metal overlayer, 9.
11. The metal overlayer deposited on a silicon-based ceramic interlayer, 12.
12. The silicon-based ceramic interlayer deposited on a thin layer of the porous and carbonaceous substrate, as in carbon-nanotube paper, shown as 13.
13. The layer of porous carbonaceous substrate, as in 13, supported on a substrate, 14.
14. The substrate supporting the assembly comprising 11, 12 and 13.
15. The carbon-nanotubes, 12, coated with silicon-based interlayer, 7, which is covered the metal layer, 6.
16. The intertube pores surrounding the carbon-nanotubes in the carbon-nanotube paper.
17. The rate of hydrogen generation at different molar concentrations of the sodium borohydride solution held at pH13, at ambient temperature.
18. The early part of the hydrogen generation curve.
19. The change in the hydrogen generation rate with temperature.
20. The change in the hydrogen generation rate with decreasing thickness of the carbon-nanotube paper as described by 8.
21. The mechanism of electron transfer in the first kind of metal atom, e.g. platinum.
22. The mechanism of electron transfer in the second kind of metal atom, e.g. palladium.
23. A theoretical approach for prediction of the hydrogen generation rate as a function of the salt concentration in the aqueous solution.
24. The temperature dependence of the hydrogen generation rate as predicted by theory.

### DETAILED DESCRIPTION

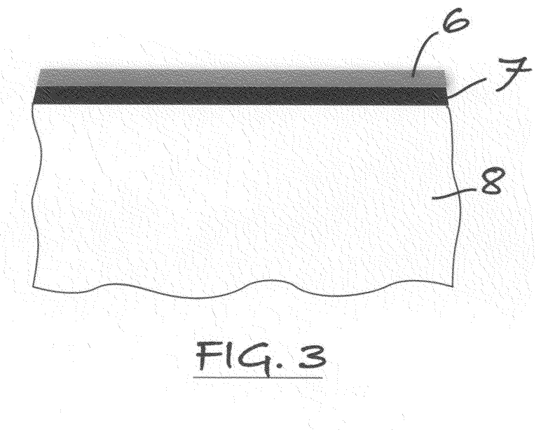

FIG. 3 shows an embodiment of a catalyst-system comprising a metallic overlayer 6 (FIG. 3), a silicon-derived interlayer 7 (FIG. 3), and a substrate 8 (FIG. 3).

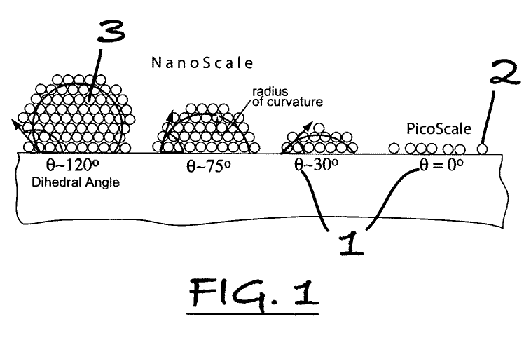

The metallic overlayer 6 is of the atomic scale, having dimensions from 100 pm (picometers) to 100 nm, and includes one or more elements commonly known as transition metals and/or elements known as noble metals. Examples of such metallic atoms include, but are not limited to, Cu, Fe, Ru, Os, Co, Rh, Ir, Ni, Pd and Pt. The metal atoms are distributed on the substrate as single atoms, 2 (FIG. 1), or as clusters 3 (FIG. 1). The metallic layer derives from single elements or a combination of several elements from the group known as transition metals and noble metals.

The silicon-based layer 7 (FIG. 3) includes, but is not limited to, silicon atoms in combination with one or more of the following atoms: oxygen, carbon, nitrogen, boron, phosphorous, and other atoms from the third, fourth and fifth column of the main group elements of the periodic table. The thickness of the silicon-based layer, 7, ranges from 0.1 nm to 10,000 nm.

The substrate material 8 (FIG. 3) includes a carbonaceous material, including but not limited to carbon nanotubes, activated carbon, or pitch carbon. The thickness of the substrate, 8, varies from 1 micron (micrometer) to 1,000 microns. The substrate material is a porous or a non-porous material, defined by its specific surface area (SSA) in units of m² g⁻¹ (meters squared per gram). The SSA of the substrate material, 8, ranges from 0.1 m² g⁻¹ to 1,000 m² g⁻¹.

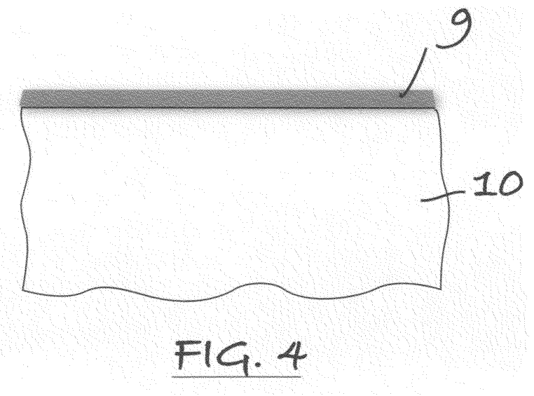

FIG. 4 shows an embodiment of a catalyst-system comprising the metal or metals, 9 (FIG. 4) and 6 (FIG. 3), deposited on a substrate, 10 (FIG. 4) constituted from the silicon-based material as in 7 (FIG. 3). The thickness of the substrate, 10, ranges from 1 micron (micrometer) to 1,000 microns.

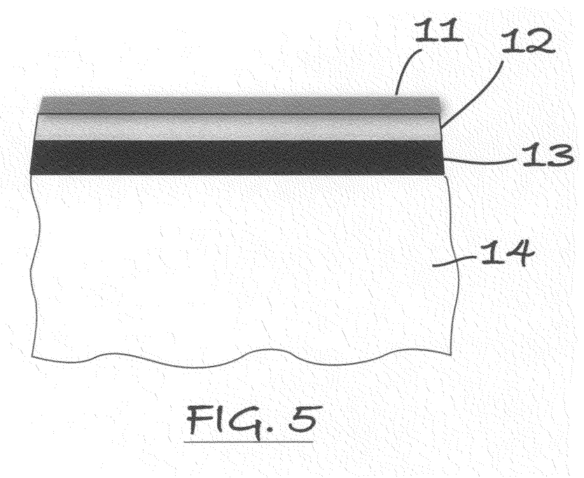

FIG. 5 shows an embodiment of a catalyst-system comprising the metal or metals, 11 (FIG. 5) or 6 (FIG. 3), deposited on a composite substrate comprising a silicon-ceramic based interlayer, 12 (FIG. 5) or 6 (FIG. 3), a thin porous layer of a carbonaceous material, 13 (FIG. 5) or 7 (FIG. 3), and a substrate of a different material, 14 (FIG. 5). The material for 14 may be electronically conducting or non-conducting; 14 may include a variety of materials including but not limited to carbon and silicon (conducting), a metal sheet, or silica glass (non conducting). The purpose of 14 in the embodiment is to support the catalyst-system. The thickness of 14 ranges from 10 microns to 1,000 microns.

The substrate in FIGS. 3, 4 and 5, 8, 10 and 14, may have various shapes, including but not limited to a sheet like material, a fiber like material, or a powder like material. The typical dimensions of these shapes, specifically the thickness of the sheet, the diameter of the fiber, and the approximate diameter of the particles in the powder, ranges from 10 microns to 1,000 microns.

FIGS. 3, 4 and 5 represent embodiments of catalyst-systems for generating hydrogen from aqueous solutions of salts that contain hydrogen, with the following attributes: (i) they are reliable, (ii) they provide control of reaction kinetics, and (iii) they possess a high degree of performance as measured by the figure-of-merit (FOM). Reliability implies that the performance of the catalyst, as measured by FOM, does not degrade after repeated use for several hundred cycles, where each cycle is defined as the exhaustion of the salt-solution of its hydrogen content. Control implies that the rate of release of hydrogen is highly predictable in terms of FOM. The FOM is defined as the rate of hydrogen generation per minute, per gram of the metals, per molar concentration of the salt in the aqueous solution. The FOM lies in the range of 10 liters min⁻¹ g.metal⁻¹ mol⁻¹ to 10,000 10 liters min⁻¹ g.metal⁻¹ mol⁻¹.

### Example 1

### Deposition of the Metal or Metals, as in 6, 9 and 11 (FIG. 3-5)

In an embodiment, the catalytic metal, 6, is deposited via impregnation of the coated support, 7, with a solution comprising a precursor of the catalytic metal followed by reduction of the precursor to metallic form. Several types of these precursors are known to the art, including metal salts and organometallic compounds. In an embodiment, the precursor is an organometallic compound. The organometallic compound may be a metal-pi-complex as described in U.S. Pat. No. 3,635,761. As described in U.S. Pat. No. 3,635,762, useful metal pi-complexes are broadly characterized by the presence of a central or nuclear metal atom having bonded thereto at least one ligand in the form of an organic group containing at least one carbon-to-carbon multiple bond. Metal pi-complexes include complexes having pi-allylic ligands, as illustrated by π-allyl-π-cyclopentadienyl-platinum.

In an embodiment, the organometallic complex is an allyl complex. A series of bis-allyl compounds is disclosed by O'Brien (1971). Platinum containing organometallic precursors such as bis(allyl) palladium, bis(2-methylallyl) palladium, and cyclopentadienyl(allyl) palladium have also been used for metal-organic chemical vapour deposition (Gozum, 1998b).

In an embodiment, the organometallic complex is dissolved in a nonaqueous solvent. In an embodiment, the solvent is an alkane like pentane or hexane. Other solvents suggested for use in chemical deposition of organometallic compounds include aromatics like benzene and toluene; halogenated alkanes and aromatics like trichloroethane, chlorobenzene, chloroform, and carbon tetrachloride; esters like methyl and ethyl acetates; ethers like dioxane and diethyl ether, ketones like acetone and methyl ethyl ketone.

The concentration of the complex in the deposition solution is selected to produce the desired amount of metal deposition. The concentration of the organometallic complex may vary over a wide range. In general, it is believed that higher concentrations favor higher deposition rates. The concentration in the solution can vary from 0.01 g L⁻¹ to 1 g L⁻¹.

During the catalyst deposition process, the solution and the coated support are brought into contact, allowing interaction between the catalyst precursor and the coated support. The coated support is then exposed to a reducing agent like hydrogen gas. The solution may be removed before the support is exposed to the reducing agent. In another embodiment, the reducing agent, for example hydrogen, may be added to the solution by bubbling the gas through the solution. The coated support is exposed to the reducing agent for sufficient time to reduce at least a portion of the complex to form elemental metal. Other reducing agents suggested for use in chemical deposition of organometallic compounds include formic acid; alkali metal hydrides; borohydrides; dibenzyl; hydrazobenzene; hydroquinone; various hydroaromatics, like cyclohexene, tetralin, 2-cyclohexene-1-one, 4-vinylcyclohexene, cyclohexadiene, and other partially saturated cycloalkenes; p-menthadienes such as limonene, the terpenes; and 1,4-dihydro-N-benzylnicotinamide.

The deposition temperature may be from room temperature, or somewhat below, to the thermal decomposition point of the catalyst precursor. The time required for the deposition depends on the amount of metal deposition desired; generally the time may extend over a period of several minutes to several hours.

### Example 2

### Preparation of Porous Carbon Nanotube Paper Coated with Silicon-Based Material, as in 7+8, and 12+13 (FIGS. 3 and 5)

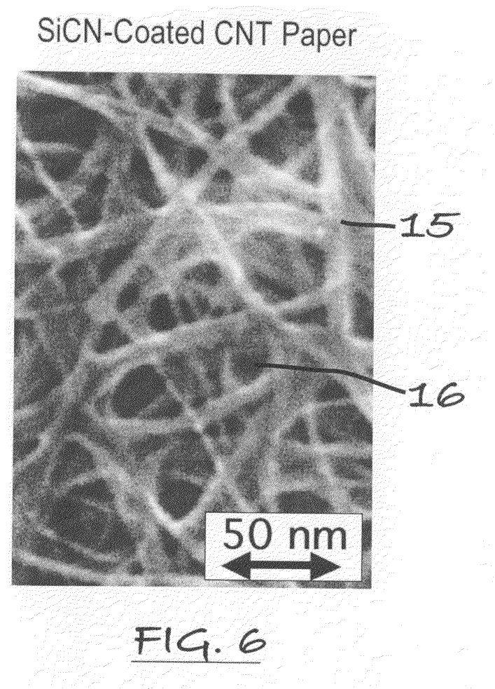

The method of preparation combines the silicon-based layer, 7 and 12, with the porous substrate, 8 and 13. The porous-layer in this example is constituted from carbon nanotubes, and is called carbon nanotube paper. A micrograph of the finished product is shown in FIG. 6. Item No. 15 in FIG. 6 points to the carbon nanotubes, and item No. 16 to the pores surrounding the carbon nanotubes.

The nanotube paper was made from purified HiPco nanotubes obtained from Carbon Nanotechnologies Inc., Houston, Tex. These single-walled nanotubes are in the form of “Bucky pearls”. The pearls are dispersed in water (50 mg CNT/L of Dl water) by adding a non-ionic surfactant, Triton X-100 procured from Alfa Aesar, Chicago, Ill., and ultrasonicating the mixture. The dispersion is filtered through 5 pm Teflon filter paper from Millipore Corporation, Bedford, Mass. A “vacuum” pulled by a roughing pump on the other side of the filter accelerates the filtration process. The nanotubes deposited on the filter are further washed with methanol and water to remove as much surfactant as possible. The tubes deposited on the filter are then peeled off as a “paper”. The nanotube paper is annealed at 1100° C. in flowing ultra high purity argon in an alumina muffle-tube furnace to burn off any remaining surfactant.

The silicon-based layer in Example 2 is constituted from a compound of silicon, carbon, nitrogen and oxygen, as is named SiCN in further description of this example. The carbon nanotube paper was coated with SiCN as follows. Commercially available silazane-based precursor Polyureamethylvinylsilazane—Ceraset™SN (Kion Corporation, Huntingdon Valley, Pa.) was used as the precursor of SiCN. Ten percent (vol %) of the Ceraset in acetone was used. About 0.2 ml of solution was used to infiltrate 40 mm diameter nanotube paper. The paper was left to dry in ambient air for about 15 min. to allow the acetone to evaporate. Next, the paper was pyrolyzed to convert the polymer into the ceramic by heating in flowing argon at 1100° C. in an alumina muffle-tube furnace.

The carbon nanotube papers were characterized in the following manner: (a) The distribution of SiCN on the carbon nanotube surfaces was characterized by energy-filtered transmission electron microscopy, which images the spatial distribution of the element Si. (b) The weight fraction of SiCN in the carbon nanotube paper was determined by burning the paper in a thermo gravimetric analyzer (STA 409 from Netzsch Instruments, Paoli, Pa.) in ambient, flowing air. (c) The specific surface area of the papers was measured by BET analyzer, model ASAP 2010 from Micromeritics Inc., Norcross, Ga.

The silicon map, of the carbon nanotube paper in FIG. 6, shows that the silicon, and therefore SiCN, is uniformly covering the entire surface of the carbon nanotubes.

The weight fraction of SiCN was measured by TGA. The metallic residue left behind in the uncoated paper has been subtracted from the data. The difference in the residue between the uncoated and the coated paper, therefore, gives the weight fraction of SiCN since the SiCN remains intact at high temperatures. The amount of residual SiCN was 50% of the starting weight. The weight fraction of SiCN, w_{SiCN}, can be converted into monolayers of SiCN, ML_{SiCN}, on the carbon nanotubes, assuming that SiCN covers the entire surface area of the nanotube structure, by the following relationship:

ML_{SiCN}═(w_{SiCN})/(1−w_{SiCN})×MW_{c}/MW_{SiCN}×(Ω_{SiCN}/Ω_{C})^{2/3}

where MW and Ω are the molecular weight and the molar volume/Avogadro's number respectively; the subscripts denote carbon in the nanotube and the SiCN molecule in the ceramic layer. The weight fraction of carbon, w_{C}=1−w_{SiCN}.

SiCN is generally considered to be a pseudo-amorphous compound, which forms over a range of compositions; therefore its density can vary (Kleebe 19991 Kroke 2000). Furthermore, the ultrathin, monolayer level, coatings being discussed here may have different physical properties than bulk materials. These issues mean that the molecular weight and the molar volume of SiCN in the coatings can be estimated only approximately. The chemical composition of bulk SiCN synthesized in our laboratory by the same process used to prepare the coating is SiC_{0.9}N_{0.57}O_{0.1}H_{0.14}. The compositions of the SiCN reported in literature vary widely, from SiC_{0.68}N_{0.48} to SiC_{1.58}N₁, while the densities range from 2.2 to 2.6 g/cm³. (While the residue obtained in the TGA was too small to be analyzed chemically, it is highly likely that its composition fell in this range.) The density of carbon is taken as 2.26 g/cm³ and the atomic volume as 0.0088 nm³. With these values the ML_{SiCN} is calculated to lie in the range 0.6-0.7.

The BET surface area analysis suggests that the nanotubes are nearly uniformly coated by SiCN. The surface to volume ratio will increase as the inverse of the effective diameter of the tubes. Assuming that the thickness of the SiCN monolayer is of the same order of magnitude as the wall thickness of the carbon nanotubes, it is to be expected that the surface area would be about one half the surface area of the uncoated sample. Indeed the BET measurements gave the following values: uncoated, 544 m²/g and coated, 290 m²/g. It is curious that the addition of the coating to the nanotube structure made little change to the physical density of the samples: while the uncoated samples had a density of 0.6 g/cm³, the coated samples had a density of 0.77 g/cm³.

Supercapacitance measurements of carbon nanotubes were made, with and without the silicon carbonitride coating. The measurement of high supercapacitance is evidence that the SiCN coating is electronically conducting. Indeed the supercapacitance of the carbon nanotubes appeared to be somewhat enhanced by the deposition of silicon carbonitride. Experiments on self-standing structures of silicon carbonitride have been shown to be electronically conducting, as well (Ryu 2006).

Further details are provided in Shah and Raj (S. R. Shah and R. Raj, J. Eur. Ceram. Soc. 25 (2005) 243-249), which is hereby incorporated by reference in its entirety.

### Example 3

### Deposition of Platinum and Palladium (as Described by Example 2) on the Surface of the Silicon-Based Material (SiCN) Deposited on the Porous Material (Carbon Nanotube Paper; as Described in Example 2)

To deposit the metal, a piece of the coated CNT-paper as prepared in Example 2 was immersed in a solution of bis-allyl palladium and bis-allyl platinum complexes in pentane under N₂ at room temperature. The metal concentrations in the solution were Pt/Pd=0.06/0.14 g L⁻¹. After 1 h, the solution was completely removed and the samples were maintained under H₂ flow for 2 h, also at room temperature. The samples, now ready for catalytic study, were stored in air. Elemental analysis of Pd and Pt content was obtained by Inductively Coupled Plasma ICP-OES Ciros (Spectro, Germany) at λ_{Pt}=214.423 nm and λ_{Pd}=340.458 nm. Fragments of the catalyst dissolved in known volumes of concentrated HCl/HNO₃ 3/1 v/v and analyzed by ICP-OES. This analysis gave values of 0.42 wt. % Pt and 0.98 wt. % Pd. The relative atomic percentages of Si, Pt and Pd atoms at and near the surface as measured by the energy dispersive X-ray method in a scanning electron microscope (EDS-SEM), gave Pt/Si ratio of 0.10 and Pd/Si ratio of 0.30.

The clustering of Pt and Pd into nanocrystals was investigated by x-ray diffraction. The x-ray diffraction spectra showed completely amorphous structure, implying that Pt/Pd were not clustered into nanocrystals. This result strongly suggests that Pt/Pd were elementally distributed on the surface of the carbon-nanotubes, especially since previous studies have shown that Pt clusters into nanocrystals, which give rise to Bragg peaks in x-ray diffraction, on “clean” carbon nanotubes (Anson 2006; Wang 2006; Tian 2006; Tian 2004; Yen 2005; Ebbeson 2002). It should be kept in mind that there are no direct methods for imaging elemental Pt and Pd on the catalyst-surface. Quantitative spectroscopic methods such as XPS, using standards as calibration, could provide this information.

### Example 4

### Measurements of Hydrogen Generation with the Catalyst-System Prepared by the Method Given in Examples 1-3: Substrate Constituted from Porous Carbon Nanotube Paper, 8 (FIG. 3); Catalyst-System Thickness in the Range of 100 Micrometers to 150 Micrometers

The volume of hydrogen produced was measured as a function of time, using a gas burette connected to the reaction flask. Both the reactor and the burette were thermostated by a water circulating apparatus. The experiments were carried out at ambient pressure in Boulder, Colo., which lies in the range 760±8 mm×0.854. The sodium borohydride solution was stirred with a magnetic spin bar at 800 rpm to promote interface-controlled reaction between the solution and the catalyst (as prepared in Example 3). All experiments were carried out with a volume of NaBH₄ solution that would have a theoretical yield of 18 ml of hydrogen at NTP. Four solution concentrations of NaBH₄, 0.03, 0.02, 0.015 and 0.01 M, were prepared. The solutions were buffered at pH 13 with KCl/NaOH. Fresh solutions were prepared immediately before every hydrogen generation experiment. In all experiments the theoretically predicted conversion of NaBH₄ into hydrogen was achieved. The experiments with the four molar concentrations were carried out at 29° C. Additionally, experiments were done at 40° C., 50° C., and 59° C. at 0.03M in order to determine the activation energy for the catalytic reaction. All experiments were done with the same catalyst, which had a total weight of 4.1-4.7 mg. The performance of this catalyst remained unchanged even after the same catalyst had been used in twenty experimental runs.

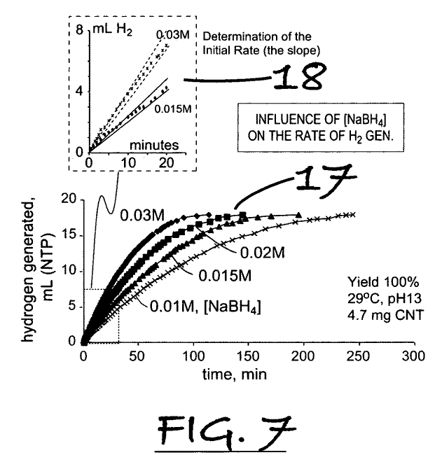

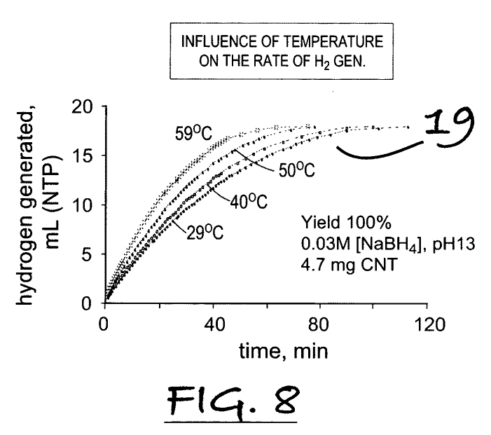

The two sets of results are shown in FIGS. 7 and 8. The first result, 17 FIG. 7, gives the hydrogen generation profile for the sets of experiments at 29° C. carried out at four molar concentrations of NaBH₄. The inset, 18, in FIG. 7 shows the procedure for determining the initial rate of hydrogen generation. The average slopes of hydrogen generated versus time for the first twenty minutes of the data were used to obtain a value for these initial rates. The second result, 19 FIG. 8, shows the data obtained for the 0.03M NaBH₄ solution at four temperatures.

The data in FIG. 7 show that hydrogen generation depends on the molar concentration of the salt in the aqueous solution. Hydrogen may be generated by contacting a supported catalyst composition of the invention with a solution comprising water, an effective amount of a hydride salt, and an effective amount of a reaction stabilizing agent. In an embodiment, the hydride salt is NaBH₄ or LiBH₄. In an embodiment, the concentration of hydride salt is between 0.001 to 1.0 molar solution in water. In an embodiment, the reaction stabilizing agent is NaOH. Since addition of NaOH makes the hydride salt solution basic, NaOH also acts as a buffering agent. In an embodiment, the concentration of NaOH is adjusted to achieve a pH of 7 to 13. In an embodiment the temperature of hydrogen generation ranges from the ambient to 95 degrees Centigrade.

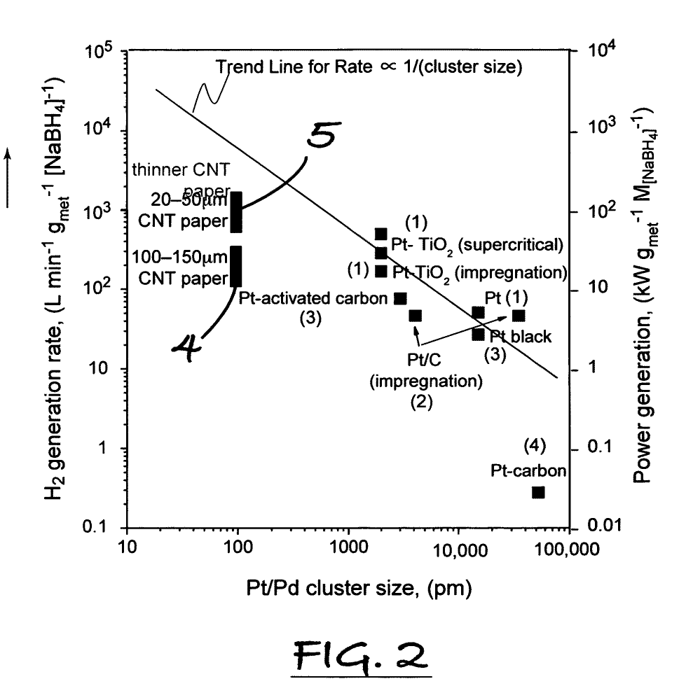

The FOM calculated from the experiments described in Example 4, are shown by 4 in FIG. 2. The FOM ranges from 100-350 litres of hydrogen generated per minute per gram of the metal content per molar concentration of the hydrogen salt in the aqueous solution (L min⁻¹ g.metal⁻¹ mol⁻¹).

### Example 5

### Measurements of Hydrogen Generation with the Catalyst-System Prepared by the Method Given in Examples 1-3: Substrate Constituted from Porous Carbon Nanotube Paper, 8 (FIG. 3); Catalyst-System Thickness in the Range of 25 Micrometers to 100 Micrometers

The embodiment described in Example 5 comprised of a highly porous substrate made of carbon nanotube paper with a thickness of 100 microns (micrometers) to 150 microns. A micrograph of the paper is given in FIG. 6; in this FIG. 16 shows the nanometer scale porosity. The hydrogen is expected to be released from the surface of the catalyst in the form of bubbles. Because of the fine porosity, the bubbles generated within the carbon nanotube paper, away from the outer surface of the paper, will become trapped in the pores and will not be released. In effect only the surface layer of the carbon nanotube is of significant usefulness in hydrogen generation. Since the metals, platinum and palladium, are deposited throughout the entire thickness of the nanotube paper, only the metal deposited near the outer surfaces of the carbon nanotube paper is useful for catalysis. The FOM, which increases if the amount of the metal used in the catalysis is less, can therefore be increased by reducing the overall thickness of the carbon nanotube paper. Indeed, the FOM is expected to be proportional to the inverse of the paper thickness.

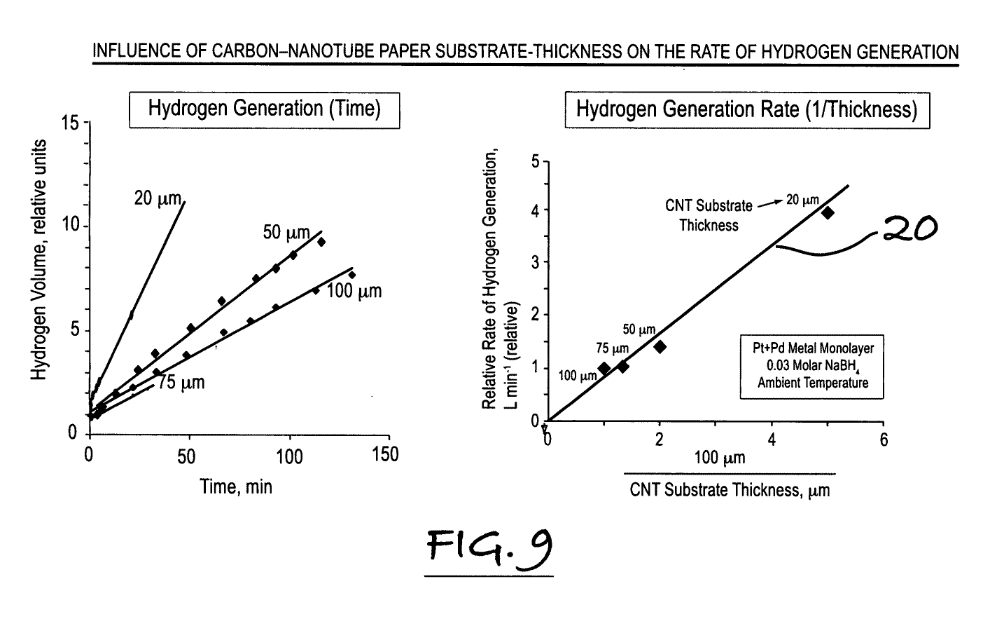

An embodiment to investigate the prediction of inverse dependence of FOM on the carbon nanotube paper thickness was investigated. The results showing the variation of the rate of hydrogen generation with inverse thickness of the carbon nanotube paper are shown in FIG. 9. A linear relationship between the rate of hydrogen generation and the inverse of the thickness is shown in 20 (FIG. 9). A decrease in the thickness of the carbon nanotube paper from 100 microns to 20 microns increases the rate of hydrogen generation by a factor of 4 to 4.5. This increase in the rate of hydrogen generation is shown by 5 in FIG. 2.

### Example 6

### Theory—Surface to Volume Ratio of Metal Clusters

We draw upon the derivations for the surface area and the volume of voids of a lenticular shape at grain boundaries in solids, to obtain an explicit expression for the surface to volume ratio for the cluster. The volume of the cluster of a spherical segment, as shown in FIG. 1, is given by r³.(π/3)(2−3 cos θ+cos³θ) while its surface area is given by r².2π(1−cos θ) (Raj 1975). Therefore the surface to volume ratio of the cluster is given by H(θ)/r, where:

$$H ( θ ) = \frac{6 ( 1 - cos θ )}{2 - 3 cos θ + {cos}^{3} θ} \qquad ( Eq . 1 )$$

The number of atoms in the volume of the cluster is equal to the volume divided by the effective volume per atom of the metal, which is written as Ω. Similarly, the number of atoms on the surface is equal to the surface area divided by Ω^{2/3}. Therefore the ratio, n [symbol] , is also proportional to Ω^{1/3}. Combining this result with the r dependence of the surface to volume ratio leads to the following equation:

$${n}_{s} = \frac{{Ω}^{1 / 3}}{r} H ( θ ) \qquad ( Eq . 2 )$$

The influence of θ, 1, on n, can be immediately seen from the schematic in FIG. 1. This dependence is given explicitly by the function H(θ), for example for θ=90°, 60°, 30°, 15°, and 5°, H(θ)=3.0, 4.8, 15.6, 132, and 526, respectively, that is, the surface to volume ratio increases rapidly with a reduction in the contact angle. In the limiting case when θ→0, both r and H(θ)→∞, and the ratio n,→l, its highest possible value.

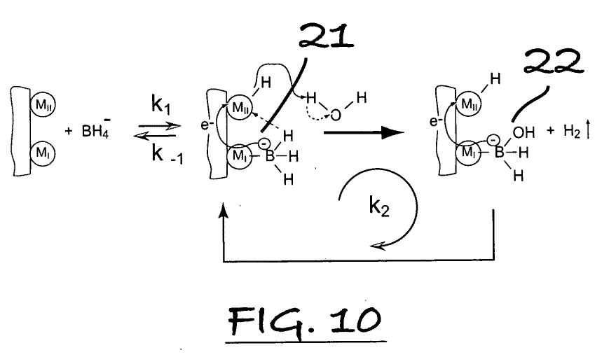

The data are analyzed in terms of the mechanism illustrated in FIG. 10. It involves two essential kinetic steps. In the first step, 21, the BH₄ ions in the solution are chemisorbed to the metal atoms. The forward rate of the process is described by the kinetic rate constant k₁, and the backward rate, which is the desorption rate of the ions back into the solution, by k₋₁. The rate constants are defined by equations such as the one given below for the forward reaction:

$${[ \frac{d [ {MBH}_{4}^{-} ]}{d t} ]}_{forward} = {k}_{1} [ {BH}_{4}^{-} ] [ M ] \qquad ( Eq . 3 )$$

where [MBH₄⁻] is equal to metal sites that are occupied, [M] is the molar concentration of metal sites that remain unoccupied, and [BH₄⁻] is the molar concentration of the ions in the solution. Note that the reaction rate is proportional to the first power of [M], because the primary reaction occurs between the unoccupied metal sites and BH₄ ions. The significance of the second metal atom which aids the kinetic pathway, as illustrated in FIG. 10, is expressed via the rate constant k₁. However, k₁ will become sensitive to [M] only if the metal atom concentration is so lean that the catalytic reaction becomes limited by the probability of finding an vacant metal site adjacent to the M−BH₄⁻ site, which in most instances is unlikely since the concentration of metal atoms on the catalyst surface will usually be high.

In the second step, 21 FIG. 10, the negative charge on the BH₄ ion is transferred with one hydrogen atom, via the CNT-PDC structure to the adjacent metal atom (Chan 1980). The electronic conductivity of the CNT/PDC support is important in such electron transfer (Shah 2005). It is possible that the different electron chemical potential of the Pt and Pd atoms facilitates this process. This feature may improve the catalytic performance since the M_{I}-M_{II}-BH₃ configuration is suitable for OH⁻ substitution at the B atom. In organometallic metal-alkyl complexes the reconstruction of HOBH₃⁻ anion is invoked as an alternative to BH₃ dissociation, with the assumption that BH₄⁻ and (HO)ₙBH₄₋ₙ⁻ are equally reactive at the catalytic site.

Next, the charged hydrogen atom reacts with a water molecule to produce H₂ and an OH which reacts with boron to produce the BH₃(OH) ion (Hua 2003). The cycle of charge transfer continues as BH₃(OH)→BH₂(OH)₂⁻→BH(OH)₃→B(OH)₄, releasing molecular hydrogen at each step. Finally the B(OH)₄⁻ reacts with Na [symbol] to produce NaBO₂. The rate constant for this second cycle, that is the conversion of the metal borohydride complex, MBH₄⁻, into hydrogen and B(OH)₄, is written as k₂. The entire reaction can now be summarized in the following way:

$$M + {BH}_{4}^{-} {{⇄}^{{k}_{1}}}_{{k}_{- 1}} {MBH}_{4}^{-} {{\to }^{4 {H}_{2} O}}_{{k}_{2}} M + 4 {H}_{2} ↑ + {B ( OH )}_{4}^{-} \qquad ( Eq . 4 )$$

The reaction in Eq. (4) is analyzed in Example 5 and leads to the following result:

$$\frac{1}{v} = \frac{1}{{k}^{′}} \cdot \frac{1}{{[ {( Na BH )}_{4} ] [ M ]}_{0}} + \frac{1}{{k}_{2}} \cdot \frac{1}{{[ M ]}_{0}} \qquad ( Eq . 5 )$$

where [M]₀ is the molar concentration of the maximum number of metal sites available in the solution for the reaction, and [NABH₄] is the molar concentration of the sodium borohydride remaining in the solution at any time. The derivation of Eq. (5) assumes that sodium borohydride is fully ionized in the aqueous solution. In Eq. (5), v is the rate of consumption of sodium borohydride:

$$v = - \frac{d [ {NaBH}_{4} ]}{d t} \qquad ( Eq . 6 )$$

In Eq. (5), k′, which represents the phenomenological first order rate constant, is given by:

$${k}^{′} = \frac{{k}_{1} {k}_{2}}{{k}_{2} + {k}_{- 1}} \qquad ( Eq . 7 )$$

The result in Eq. (7) shows that the first order rate constant, k′, is a complex quantity depending on three rate constants, k₁, k₁, and k₂. The equation has two limits: if k₂>>k₁, then k′→k₂, but if k₂<<k₁, then k′→k₁k₂/k₁.

Experiments that measure hydrogen generation are usually carried out with parameters that are related to, but are not explicitly the same as those in Eq. (5). In a typical experiment, the hydrogen generated is measured in L min⁻¹ from a solution of a prescribed molar concentration of NaBH₄, with a certain amount of the metal catalyst, usually reported in grams. Therefore we define a new set of parameters that can be more easily related to experiments:

[NaBH₄] Molar concentration of NaBH₄ in the solution (in mol L⁻¹).
n_{H}_{₂} Moles of hydrogen generated from the solution of sodium borohydride.
MWₘₑₜ Average molecular weight of the metal species.
V Volume of the solution (in L).
gₘₑₜ Total metal content in grams in the solution.
K₁ Experimental first order rate constant in units of mol H₂ min⁻¹ gₘₑₜ⁻¹ [NaBH₄]⁻¹.
K₂ Experimental zero order rate constant in units of mol H₂ min⁻¹ gₘₑₜ⁻¹.
Since one mole of NaBH₄ produces four moles of H₂ we have that:

$$\begin{matrix}\frac{d {n}_{{H}_{2}}}{d t} = - 4 V \frac{d [ {( Na BH )}_{4} ]}{d t} \\ Also , & ( Eq . 8 ) \\ {[ M ]}_{o} = \frac{{g}_{met}}{{MW}_{met} V} & ( Eq . 9 )\end{matrix}$$

Substituting Eqns (8) and (9) into Eqns (5) and (6) we obtain:

$$\begin{matrix}\frac{1}{( d {n}_{{H}_{2}} \text{/} d t )} = \frac{1}{{K}_{1}} \cdot \frac{1}{[ {( Na BH )}_{4} ] {g}_{met}} + \frac{1}{{K}_{2}} \cdot \frac{1}{{g}_{met}} \\ where , & ( Eq . 10 ) \\ {K}_{1} = \frac{4 {k}^{′}}{{MW}_{met}} , \\ and \\ {K}_{2} = \frac{4 {k}_{2}}{{MW}_{met}} & ( Eq . 11 )\end{matrix}$$

The comparison of the experimental data with Eq. (10), will yield the phenomenological first order and zero order rate constants, K₁ and K₂. The process is to plot the inverse of the initial hydrogen generation rate against the inverse of the initial value of [NaBH₄]. The results should fit a straight line. The slope of the line yields a value for K₁, while the intercept of the line for the limit (1/[NaBH₄])→0 gives K₂. (Zhang 2006 discusses combined zero and first order kinetics in a Ru-on-carbon catalyst. However, while they distinguish between zero and first order in terms of temperature, in the present work the molar concentration of sodium borohydride forms the basis for distinguishing between these two mechanisms).

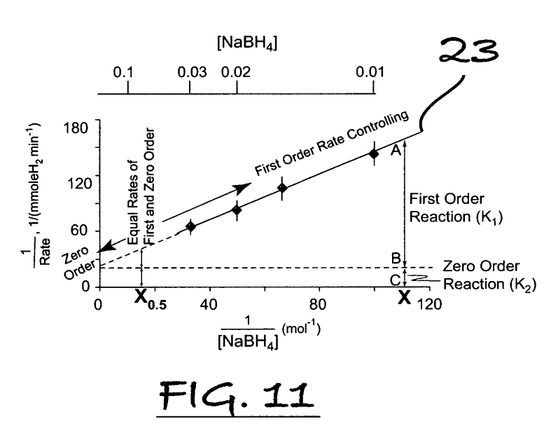

The above plot for the present data is given in FIG. 11. A good straight line fit, 23 FIG. 11, as predicted by Eq. (10) is obtained. The intercept and the slope of the line lead to the following values for the rate constants: K₁=12.9 mol H₂ min⁻¹ gₘₑₜ⁻¹ [NaBH₄]⁻¹′, and K₂=0.7 mol H₂ min⁻¹ gₘₑₜ⁻¹.

The graph in FIG. 11 provides an insight into the relative contribution of first order and zero order reactions in hydrogen generation. For example, at the point denoted by X along the horizontal axis the fraction of hydrogen generated by the first order reaction is given by the ratio AB/AC. The remaining fraction, given by BC/AC is the contribution from the zero order reaction. This relationship changes with concentration. At concentration X_{0.5}, for example, the two types of reactions make an equal contribution. If X<X_{0.5} then the zero order reaction is dominant, and the first order is more important if X>X_{0.5}. In the present experiments the first order reaction played the dominant role, since the concentrations were in the X>X_{0.5} regime.

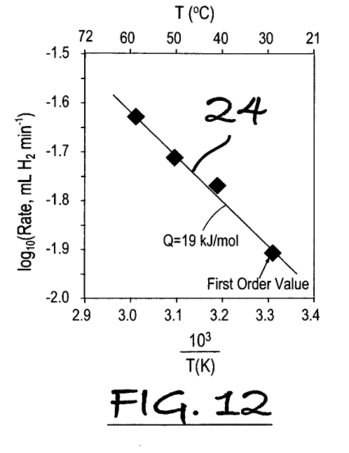

With the above analysis it is possible to estimate the activation energy for the hydrogen generation process, by writing the rate constant ∝exp (−Q/RT). A simple Arrehenius plot of the results, where the logarithm of the rate, mL of H₂ (at NTP) generated in 20 minutes, is plotted against inverse temperature, is given in FIG. 12. The point at 29° C. is obtained by considering only the first order component of the reaction rate from the plot in FIG. 11. A good linear fit, 24 FIG. 12, with an activation energy of 19 kJ mol⁻¹ is obtained. This activation energy is presumed to apply to the first order rate constant. In comparison Amendola et al. (2000) in their experiments at high NaBH₄ and low NaOH concentration, obtained 56 kJ mol⁻¹. Hua et al. (2003) who measured hydrogen generation with a NiₓB catalyst obtained an activation energy of 38 kJ/mol. The lower value for the activation energy in the present experiments reflects the specificity of the Pt/Pd—Si catalytic sites.

The constants and the values used for various calculations in the text were as follows: (i) mL of H₂ generated in the experiments were converted into NTP mL (at 273 K and 101 Pa, pressure) by assuming the atmospheric pressure in Boulder, Colo. to be 0.85×101 Pa, (ii) As 1 mol of NaBH₄ produces 4 mol of H₂, the conversion factor for [NABH₄] into L of H₂ (NTP) was V_{H2}=4(M_{NaBH4} Vₛₒₗᵤₜᵢₒₙ R T)/P using T (temperature) and P (pressure) the corresponding values for NTP conditions, (iii) One L of H₂ (NTP) generated in one minute is equivalent to 100 W of electrical power at 0.7 V, and (iv) The experiments were done with 4.7 mg of catalyst which contained 0.42 wt % of Pt and 0.98 wt. % of Pd. The atomic weight of Pt and Pd are 195 and 106 g mol⁻¹. Thus, the catalyst used in the experiments contained 5×10⁻⁷ mol of metal atoms.

The understanding of the kinetics of hydrogen generation is important for prediction of its performance in a fuel cell. The result given in Eq. (5) provides a way of assessing the relative importance of the first order and second order kinetics (the slower one is rate controlling). The data from the present work shows that first order plays a dominant role. The results in the literature are unclear on this issue. It is generally stated that metals on oxides show a zero order kinetics, but a careful examination of the data often shows that first order kinetics is also a contributing factor, as discussed in a recent paper (Zhang 2006). The methodology presented here can help to clarify the relative contribution from zero and first order kinetics in hydrogen generation experiments.

### REFERENCES

All patent applications and literature cited herein are incorporated by reference in their entirety.
S. C. Amendola, S. L. Sharp-Goldman, M. S. Janjua, N. C. Spencer, M. T. Kelly, P. J. Petillo, M. Binder, “An ultrasafe hydrogen generator:aqueous, alkaline borohydride solutions and Ru catalyst” J. Power Sources 85[2] (2000) 186-189.
S. C. Amendola, M. Binder, M. T. Kelly, P. J. Petillo, S. L. Sharp-Goldman, in Hydrogen Energy, Kluwer Academic/Plenun Press, New York, 2002, p. 69.
S. C. Amendola, S. L. Sharp-Goldman, M. S. Janjua, N. C. Spencer, M. T. Kelly, P. J. Petillo, M. Binder, “A safe, portable, hydrogen gas generator using aqueous borohydride solution and Ru catalyst” Int. J. Hydro. Ener. 25[10] (2000) 969-975.
S. C. Amendola, S. L. Sharp-Goldman, M. S. Janjua, M. T. Kelly, P. J. Petillo, M. Binder, “An ultrasafe hydrogen generator:aqueous, alkaline borohydride solutions and Ru catalyst” J. Power Sources 85[2] (2000) 186-189
A. Ansoón, E. Lafuente, E. Urriolabeitia, R. Navarro, A. M. Benito, W. K. Maser, M. T. Martinez, “Hydrogen capacity of palladium-loaded carbon materials”, Phys. Chem. B, 110 [13] (2006) 6643-6648.
E. P. Barret, L. G. Joyner and P. H. Halenda, “The determination of pore volume and area distributions in porous substances. I. Computations from nitrogen isotherms” J. Am. Chem. Soc., 73[1] (1951) 373-380.
M. Boudard, “Catalysis by supported metals” Adv. Catal. 20 (1969) 153-166.
H. C. Brown, c. A. Brown, “New, highly active metal catalysts for the hydrolysis of borohydride” J. Am. Chem. Soc. 84[35] (1962) 1493-1494.
A. S. C. Chan and J. Halpern, “Interception and characterization of a hydridoalkylrhodium intermediate in a homogeneous catalytic hydrogenation reaction” J. Am. Chem. Soc., 102 (1980) 838.
Christan, M. M. at al., “Ceramic microreactors for on-site hydrogen production,” J. Catalysis (2006) 241: 235-242.
K. Cowey, K. J. Green, G. O. Mepsted, R. Reeve, “Portable and military fuel cells” Current Opinion in Solid State and Materials Science 8[5] (2004) 367-371.
T. W. Ebbesen, P. M. Ajayan, “Large-scale synthesis of carbon nanotures” Nature 358 (1992) 220.
D. Hua, Y. Hanxi, A. Sinping, C. Chuansin, “Hydrogen production from catalytic hydrolysis of sodium borohydride solution using nickel boride catalyst” Int. J. Hyd. Ener. 28[10] (2003) 1095-1100.
S. J. Gregg and K. S. W. Sing, “Adsorption, surface area and porosity” Academic Press, London, 1982, pp. 285-286.
J. E. Gozum, D. M. Pollina, J. A. Jensen, G. S. Girolami, “Tailored organometallics as precursors for the chemical vapor deposition of high-purity palladium and platinum thin films” J. Am. Chem. Soc. 100 (1988a) 2688-2689.
E. J. Gozum, D. M. Pollina, J. A. Jensen, G. S. Girolami, “Tailored Organometallics as precursors for the chemical vapor deposition of high-purity Palladium and Platinum thin films” J. Am. Chem. Soc. 110-[8] (1988b) 2688-2689.
K. A. Holbrook, P. J. Twist, “Hydrolysis of the borohydride ion catalysed by metal-boron alloys” J. Chem. Soc. A: Inorganic Physical, Theoretical 7 (1971) 890-894.
B. D. James, M. G. H. Wallbridge, “Metal tetrahydroborates” Prog. Inorg. Chem. 11 (1970) 200-231.
H. J. Kleebe et al., In Precursor Derived Ceramics, ed. J. Bill et al., Wiley-VCH, Weinghein, Germany, 1999, pp. 113-131,
E. Kroke et al., Mat. Sci. Engr. R., 2000, 26(406), 97-199)
Y. Kojima, K-I. Suzuki, K. Fukumoto, Y. Kawai, M. Kimbara, H. Nakanishi, S. Matsumoto, “Development of 10 kW-scale hydrogen generator using chemical hydride” J. Power Sources 125[1] (2004) 22-26.
Y. Kojima, K-I. Suzuki, K. Fukumoto, M. Sasaki, T. Yamamoto, Y. Kawai, H. Hayashi “Hydrogen generation using sodium borohydride solution and metal catalyst coated on metal oxide” Int. J. Hyd. Energy 27[10] (2002) 1029-1034.
Y. Kojima, K-I. Suzuki, Y. Kawai, “Hydrogen generation from lithium borohydride solution over nano-sized platinum dispersed on LiCoO₂” J. Power Sources 155[2] (2006) 325-328.
P. Krishnan, T-H. Yang, W-Y. Lee, C-S. Kim, “PtRu—LiCoO₂— an efficient catalyst for hydrogen generation from sodium borohydride solutions” J. Power Sources 143[1-2] (2005) 17-23.
W. Z. Li et al., “Carbon nanotubes as support for cathode catalyst of a direct methanol fuel cell”, Carbon (2002), 40(5)L 791-794.
Z. L. Liu et al., “Preparation and characterization of platinum-based electrocatalysts on multiwalled carbon nanotubes for proton exchange membrane fuel cell,” Langmuir (2002), 18: 4054-60.
V. Lordi et al., “Method for supporting platinum on single-walled carbon nanotubes for a selective hydrogenation catalyst”, Che. Mater. (2001), 13: 733-7.
S. O'Brien, M. Fishwick, B. McDermott, M. G. H. Wallbridge, G. A. Wright, “Isoleptic allyl derivatives of various metals” Inorg. Synth. 13 (1971) 73-79.
S. Ozkar, M. Zahmakiran “Hydrogen generation from hydrolysis of sodium borohydride using Ru(0) nanoclusters as catalyst” J. Alloys and Compounds 404-406 (2005) 728-731.
R. Peña-Alonso, A. Sicurelli, E. Callone, G. Carturan and R. Raj, “PicoScale Catalyst for Hydrogen Generation from NaBH₄” J. Power Sources, 165 (2007) 315-323.
R. Raj and M. F. Ashby, “Intergranular fracture at elevated temperature,” Acta Metall., 23 (1975) 653-666.
H.-Y. Ryu and R. Raj, “Titanium Nitride Interconnects for Polymer-Derived Silicon-Carbonitride Semiconductors for Service at Temperatures up to 1300° C.”, J. Amer. Ceram. Soc., early on-line (2006).
L. Schlapbach, A. Zuttel, “Hydrogen-storage materials for mobile applicatios” Nature 414 [6861] (2001) 353-358.
H. I. Schlesinger, H. C. Brown, A. E. Finholt, J. R. Gilbreath, H. R. Hoekstra, E. K. Hyde, “Sodium borohydride, its hydrolysis and its use as reducing agent and in the generation of hydrogen”, J. Am. Chem. Soc. 7[1] (1953) 215-219.
S. R. Shah, R. Raj, “Nanodevices that explore the synergies between PDCs and carbon nanotubes”, J. Eur. Cer. Soc. 25[2-3] (2005) 243-249.
S. Suda, Y. M. Sun, B. H. Liu, Y. Zhow, S. Morimitsu, K. Arai, N. Tsukamoto, M. Uchida, Y. Candra, Z. P. Li, “Catalytic generation of hydrogen by applying fluorinated-metal hydrides as catalysts” Appl. Phys. A 72[2] (2001) 209-212.
H. Tang et al. “High dispersion and electrocatalytic properties of platinum on well-aligned carbon nanotube arrays”, Carbon 42 (2004), 191-197.
Z. Q. Tian, S. P. Jiang, Y. M. Liang, P. K. Shen, “Synthesis and characterization of platinum catalysts on multiwalled carbon nanotubes by intermittent microwave irradiation for fuel cell applications” J. Phys. Chem. B 110[11] (2006) 5343-5350.
Z. Q. Tian, F. Y. Xie, P. K. Shen, “Preparation of high loading Pt supported on carbon by on-site reduction”, J. Mat. Sci. 39 (2004) 1507-1509.
H. Tsuchiya, O. Kobayashi, “Mass production cost of PEM fuel cell by learning curve” Int. J. Hyd. Energy 29[10] (2004) 985-990.
C. H. Yen, X. Cui, H. B. Pan, S. Wang, Y. Lin, C. M. Wai, “Deposition of platinum nanoparticles on carbon nanotubes by supercritical fluid method” J. Nanosci. Nanotech. 5 (2005) 1852-1857.
T. Wang, X. Hu, X. Qu, S. Dong “Noncovalent functionalization of multiwalled carbon nanotubes: application in hybrid nanostructures” J. Phys. Chem. B 110 [13] (2006) 6631-6636.
J-H. Wee, “A comparison of sodium borohydride as a fuel for proton exchange membrane fuel cells and for direct borohydride fuel cells” J. Power Sources, 155[2] (2006) 329-339.
J-H. Wee, K-Y. Lee, S. H. Kim, “Sodium borohydride as the hydrogen supplier for proton exchange membrane fuel cell systems” Fuel Processing Technology, 87[9] (2006) 811-819.
C. Wu, F. Wu, T. Bai, B. Yi, H. Zhang “Cobalt boride catalysts for hydrogen generation from alkaline NaBH₄ solution” Materials Letters, 59 [14-15] (2005) 1748-1751.
C. Wu, H. Zhang, B. Yi, “Hydrogen generation from catalytic hydrolysis of sodium borohydride for proton exchange membrane fuel cells” Catalysis Today 93-95 (2004) 477-483.
J. S. Zhang, W. N. Delgass, T. S. Fisher and J. P. Gore, “Kinetics of Ru—Catalyzed Sodium Borohydride Hydrolysis”, J. Power Sources, available on-line December 2006.

We claim:

1. A catalyst system, comprising:
a metal layer disposed upon at least a portion of a surface of a silicon-based layer,
wherein the catalyst system is adapted for production of hydrogen.

2. The catalyst system of claim 1, wherein said metal layer comprises a metal selected from transition metals, noble metals, and combinations thereof.

3. The catalyst system of claim 1, wherein said metal layer comprises a metal selected from the group consisting of Cu, Fe, Ru, Os, Co, Rh, Ir, Ni, Pd, Pt, and combinations thereof.

4. The catalyst system of claim 1, said metal layer further comprising an element selected from oxygen, sulfur, halogens, carbon, nitrogen, phosphorus, silicon, and combinations thereof.

5. The catalyst system of claim 1, wherein the catalyst system has a shape selected from the group consisting of a sheet, a fiber, individual particles, and combinations thereof.

6. The catalyst system of claim 5, wherein a thickness of the sheet is between ten micrometers and one millimeter.

7. The catalyst system of claim 5, wherein a diameter of the fiber is between ten micrometers and one millimeter.

8. The catalyst system in claim 5, wherein a size of the individual particles is between ten micrometers and one millimeter.

9. The catalyst system of claim 1, said silicon-based layer further comprising an element selected from the group consisting of carbon, nitrogen, oxygen, boron, phosphorus, aluminum, and combinations thereof.

10. The catalyst system of claim 1, further comprising a substrate disposed adjacent said silicon-based layer.

11. The catalyst system of claim 1, further comprising a porous layer disposed adjacent said silicon-based layer.

12. The catalyst system of claim 11, wherein said porous layer comprises a material selected from the group consisting of carbon, carbon nanotubes, activated carbon, silicon, conducting materials, and combinations thereof.

13. The catalyst system of claim 11, wherein said silicon-based layer has a thickness ranging from 0.1 nm to 1000 nm.

14. The catalyst system of claim 11, wherein said silicon-based layer occupies at least a portion of void space within said porous layer.

15. The catalyst system of claim 11, further comprising a substrate disposed adjacent said porous layer.

16. The catalyst system of claim 15, wherein said substrate comprises a material selected from the group consisting of a conducting material and a non-conducting material.

17. The catalyst system of claim 11, further comprising a second silicon-based layer disposed adjacent said porous layer.

18. The catalyst system of claim 17, said second silicon-based layer further comprising an element selected from the group consisting of carbon, nitrogen, oxygen, boron, phosphorus, aluminum, and combinations thereof.

19. The catalyst system of claim 17, further comprising a substrate disposed adjacent the second silicon-based layer.
